(19) United States
(12) Patent Application Publication
(10) Pub. No.: US 2003/0039298 A1
(43) Pub. Date: Feb. 27, 2003

(54) System and method of vehicle climate control

(75) Inventors: Harry S. Eriksson, Trollhattan (SE); Christer Andersson, Trollhattan (SE)

Correspondence Address: BROOKS & KUSHMAN P.C. / LEAR CORPORATION, 1000 TOWN CENTER TWENTY-SECOND FLOOR, SOUTHFIELD, MI, 48075, US

(73) Assignee: LEAR CORPORATION, Southfield, MI

(21) Appl. No.: 10/222,266

(22) Filed: Aug. 16, 2002

Related U.S. Application Data
(60) Provisional application No. 60/314,286, filed on Aug. 22, 2001.

(51) Int. Cl. G01K 3/00

(52) U.S. Cl. 374/109

(57) ABSTRACT

A climate control system for a passenger compartment of a vehicle provides temperature and moisture sensors disposed at or near the surface of the seats. The temperature and moisture sensors provide input signals to an electronic control unit, which processes the signals based on a preprogrammed algorithm. The control unit then operates one or more climate control devices, chosen from a set of climate control devices. The set of climate control devices includes fans, heating mechanisms, and a heating and cooling subsystem. The fans and heating mechanisms are disposed in relation to each seat within the vehicle, to move heated air to or from the surface of the seat. The heating and cooling subsystem may include the vehicle's central heating and cooling system.

### CROSS-REFERENCE TO RELATED APPLICATIONS

This application claims the benefit of U.S. provisional application Serial No. 60/314,286 filed Aug. 22, 2001.

### BACKGROUND OF THE INVENTION

1. Field of the Invention

The present invention relates to a system and method of vehicle climate control.

2. Background Art

There currently exists a wide variety of climate control systems for controlling the climate in the interior of a vehicle. Systems may rely on inputs for determining the climate conditions, and then may control the climate in the vehicle interior using any one of a number of devices and methods. For example, U.S. Pat. No. 4,920,759 issued to Tanaka et al. on May 1, 1990 describes a radiant heat control apparatus for an automotive vehicle. The apparatus includes a number of radiant heat sensors positioned in various locations throughout the vehicle interior, such as on the occupant seats. In addition, temperature sensors may be located in positions throughout the vehicle interior. The radiant heat sensors and the temperature sensors signal a controller, which then controls operation of heating and cooling devices located throughout the vehicle interior.

Despite its reliance on inputs from a number of sensors, Tanaka et al. does not consider the moisture content at or near the interface of a seated occupant and an occupied seat. Because the human body cools itself with an evaporative cooling system, the moisture content at this interface may be important to the occupant's comfort. In addition, Tanaka et al. controls the temperature of the vehicle interior using a number of heating and cooling elements throughout the interior, none of which are specifically designed to heat or cool the seats. Because the seats may act as a heat or cold sink, it may be important to the comfort level of a vehicle occupant to adjust the temperature of the occupied seat.

One attempt to overcome this limitation is found in U.S. Pat. No. 5,934,748 issued to Faust et al. on Aug. 10, 1999. Faust et al. describes a vehicle seat having temperature and/or moisture sensors that provide inputs to a control unit. The control unit then controls a ventilation and heating system within the seat, based on these inputs. The Faust et al. vehicle seat does not provide for control of the other climate conditions within the vehicle interior—e.g., the ambient air conditions. Hence, there still exists a need for a climate control system for the interior of a vehicle that controls the temperature and moisture conditions of an occupied seat, and also controls other conditions, such as the ambient air conditions within the vehicle interior.

Accordingly, it is desirable to provide an improved system and method of climate control that uses temperature and moisture inputs as a basis for controlling the climate in a passenger compartment of a vehicle, including the ambient air conditions and the temperature and moisture of the seats.

### SUMMARY OF THE INVENTION

One aspect of the invention provides a climate control system for use in a passenger compartment of a vehicle that includes ventilation within a seat for transporting moisture away from the interface of a seated occupant and the seat.

Another aspect of the invention provides a heating mechanism for heating the air near the interface of a seated occupant and a seat for evaporating some of the moisture near the interface.

A further aspect of the invention provides a climate control system for use in a passenger compartment of a vehicle that includes a temperature sensor and a moisture sensor disposed in relation to a seat for signaling an electronic control unit to selectively operate an ambient air heating and cooling subsystem.

Still another aspect of the invention provides a method of controlling the climate in a passenger compartment of a vehicle by controlling the temperature and moisture at the interface of a seated occupant and a seat, and the conditions of the ambient air within the passenger compartment.

Accordingly, a climate control system for controlling the climate in a passenger compartment of a vehicle is provided. The vehicle includes a seat, and at least one ambient air heating and cooling subsystem. The climate control system comprises a fan located in relation to the seat so it can selectively move air through at least one surface of the seat. The climate control system also includes a heating mechanism located in relation to the seat, so it can selectively heat the air being moved through the at least one surface of the seat. A first temperature sensor is disposed in relation to the seat for sensing the temperature near a surface of the seat, and for sending an electronic signal related to the temperature sensed. A first moisture sensor is disposed in relation to the seat for sensing the presence of moisture near a surface of the seat, and for sending an electronic signal related to the amount of moisture sensed. An electronic control unit receives signals from at least the first temperature sensor and the first moisture sensor. The electronic control unit controls the operation of the fan, the heating mechanism, and the at least one ambient heating and cooling subsystem, based on the signals received from at least the first temperature sensor and the first moisture sensor.

Another aspect of the invention provides a climate control system for controlling the climate in a passenger compartment of a vehicle having a seat. The climate control system comprises a first temperature sensor disposed in relation to the seat for sensing the temperature near a surface of the set, and for sending an electronic signal related to the temperature sensed. A first moisture sensor is disposed in relation to the seat for sensing the presence of moisture near a surface of the seat, and for sending an electronic signal related to the amount of moisture sensed. Also included is an ambient air heating and cooling subsystem for selectively conditioning ambient air within the passenger compartment of the vehicle. An electronic control unit receives signals from at least the first temperature sensor and the first moisture sensor and controls the operation of the ambient air heating and cooling subsystem based on the signals received from at least the first temperature sensor and the first moisture sensor.

Still another aspect of the invention provides a method of controlling the climate in a passenger compartment of a vehicle having a seat. The method comprises sensing the temperature near the interface of a seated occupant and the seat, and sending a first signal related to the temperature sensed to an electronic control unit. The moisture near the interface of the seated occupant and the seat is also sensed, and a second signal, related to the amount of moisture sensed, is sent to the electronic control unit. At least the first and second signals are processed by the electronic control unit, based on a preprogrammed algorithm. Then, at least one climate control device, chosen from a set of climate control devices, is selectively operated based on the processing by the electronic control unit. The set of climate control devices includes: a fan, disposed in relation to the seat for selectively moving air to and from the interface of the seated occupant and the seat; a heating mechanism, disposed in relation to the seat for selectively heating the air being selectively moved to and from the interface of the seated occupant and the seat; and, an ambient air heating and cooling subsystem.

A further aspect of the invention provides a method of controlling the climate in a passenger compartment of a vehicle having a seat. The method comprises sensing the temperature near the interface of a seated occupant and the seat, and sending a first signal related to the temperature sensed to an electronic control unit. The moisture near the interface of the seated occupant and the seat is also sensed, and a second signal related to the amount of moisture sensed is sent to the electronic control unit. At least the first and second signals are processed with the electronic control unit based on a preprogrammed algorithm, and an ambient air heating and cooling subsystem is selectively operated based on the processing by the electronic control unit.

Yet another aspect of the invention provides a method of controlling the climate in a passenger compartment of a vehicle having a seat. The method comprises using a preprogrammed algorithm in an electronic control unit to process input signals from at least a temperature sensor and a moisture sensor located in the seat. At least one climate control device is then selectively operated after being chosen from a set of climate control devices using the preprogrammed algorithm.

The above object and other objects, features, and advantages of the present invention are readily apparent from the following detailed description of the best modes for carrying out the invention when taken in connection with the accompanying drawings.

### BRIEF DESCRIPTION OF THE DRAWINGS

FIG. 1 shows a schematic representation of a climate control system in accordance with the present invention;

FIG. 2 shows a perspective view of a vehicle seat having porous surfaces;

FIG. 3 shows a fragmentary sectional view of a lower portion of the seat shown in FIG. 2;

FIG. 4 shows a fragmentary sectional view of a lower portion of a seat in accordance with an alternative embodiment of the present invention;

FIG. 5 shows a fragmentary perspective view of a seat in accordance with another embodiment of the invention, a lower portion of the seat having a flexible conduit attached thereto; and

FIG. 6 is a flow chart illustrating one method of controlling the climate in a passenger compartment of a vehicle in accordance with the present invention.

### DETAILED DESCRIPTION OF THE PREFERRED EMBODIMENT(S)

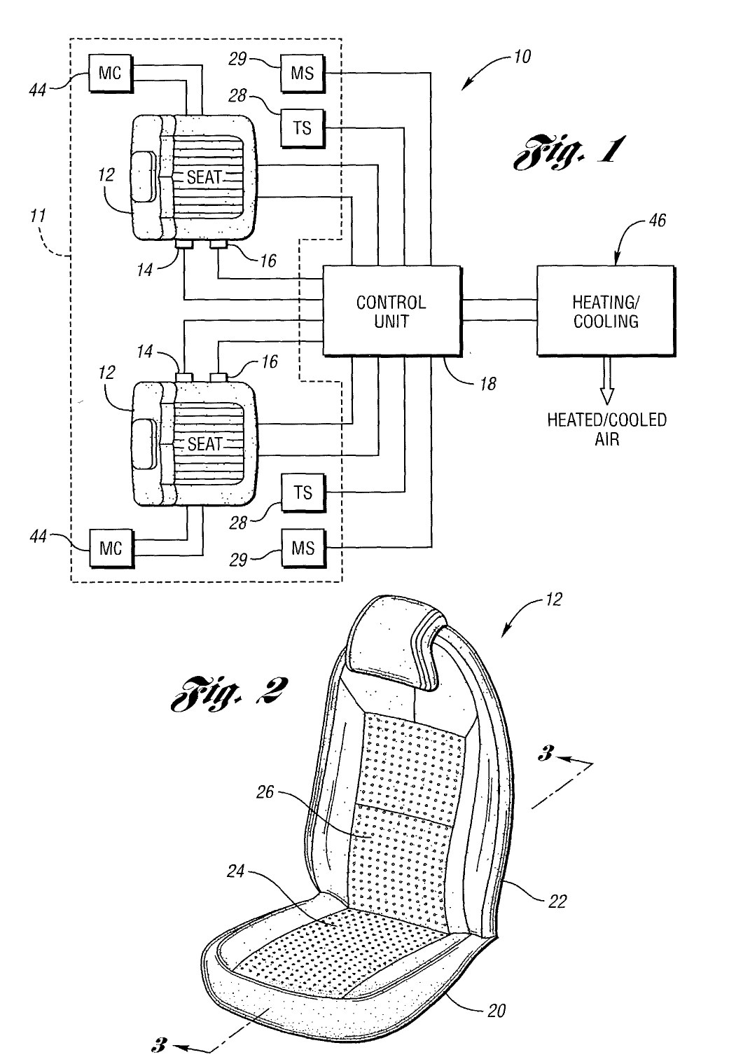

FIG. 1 schematically illustrates a climate control system 10 for use in a passenger compartment 11 of a vehicle in accordance with the present invention. Seats 12 are provided with first temperature sensors 14 and first moisture sensors 16, that are connected to an electronic control unit (ECU) 18. The first temperature sensors 14 and the first moisture sensors 16 are configured to send first and second signals, respectively, to the ECU 18. Although FIG. 1 illustrates two seats 12 provided with sensors 14, 16, a single seat, or more than two seats, may be similarly configured. Although FIG. 1 illustrates only one temperature sensor 14 and one moisture sensor 16 per seat 12, it is understood that any number of sensors 14, 16 may be used in each seat.

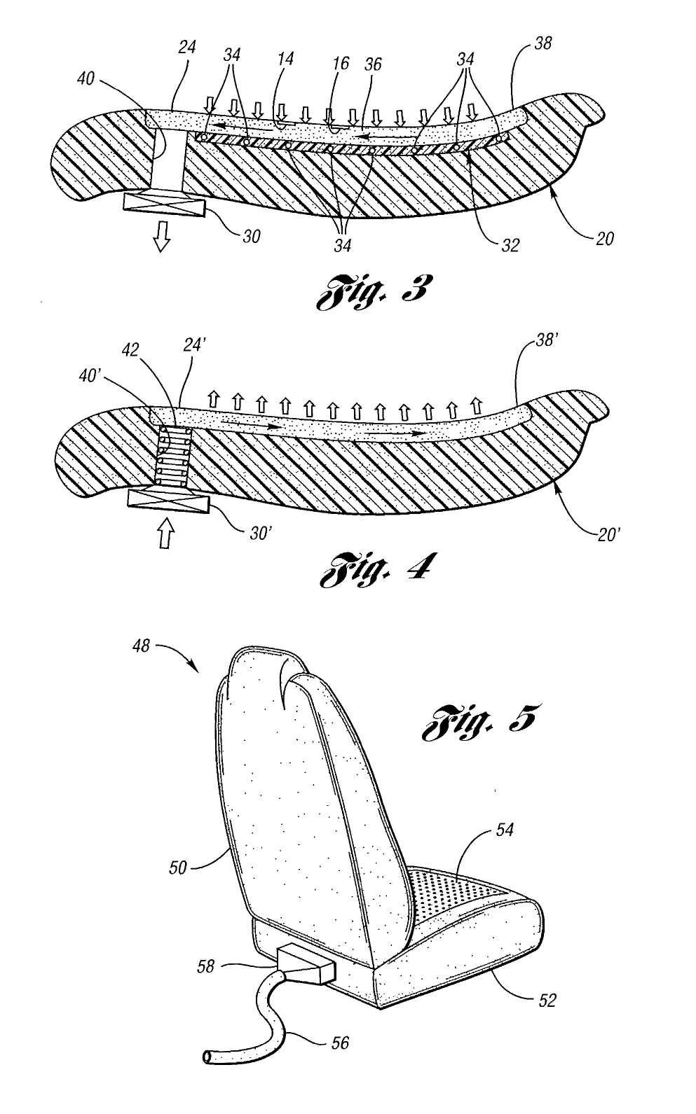

A typical seat 12, including a lower portion 20 and a back portion 22, is shown in FIG. 2. The lower portion 20 includes a first porous surface 24, and the back portion 22 includes a second porous surface 26. The temperature sensors 14 and the moisture sensors 16 will often be located just below one or both of the porous surfaces 24, 26. In FIG. 3, the sensors 14, 16 are shown located just below the first porous surface 24, which may be may be made from any suitable material or materials, such as perforated leather or vinyl, or cloth having interstices in the weave of the fabric. When an occupant (not shown) occupies the seat 12, the positioning of the sensors 14, 16 allows them to sense the temperature and moisture at or near the interface of the seated occupant and the lower portion 20 of the seat 12. Of course, additional sensors 14, 16 may be placed throughout the lower portion 20, and/or throughout the back portion 22.

The temperature sensors 14, which may be of any suitable type—e.g., a thermocouple—send signals to the ECU 18 related to the temperature sensed at or near the occupant/seat interface. Similarly, the moisture sensors 16 send signals to the ECU 18 related to the amount of moisture sensed at or near the occupant/seat interface. The moisture sensors 16 may be resistive or capacitive hygrometers, or some other type of moisture sensors capable of sending signals to an electronic control unit such as 18. In addition to the input from the first temperature and first moisture sensors 14, 16, the ECU 18 may also receive supplemental input signals from second temperature sensors 28 and second moisture sensors 29 (see FIG. 1). The sensors 28, 29 may be used to sense the temperature and moisture of the ambient air in various locations throughout the passenger compartment of the vehicle, and send third and fourth signals, respectively, to the ECU 18. Thus, the ECU 18 receives a variety of input signals related to the conditions within the passenger compartment 11 of the vehicle.

After receiving the input signals from one or more of the sensors 14, 16, 28, 29, the ECU 18 processes the signals using a preprogrammed algorithm to determine a climate control strategy. The climate control strategy includes determining which climate control devices should be operated to increase or maintain the comfort level of a vehicle occupant. In the embodiment shown in FIG. 3, the climate control devices include a fan 30 and a heating mechanism, in particular, a heater mat 32. The heater mat 32 comprises electrical resistance wire 34, disposed within a foam mat portion 36, as shown in cross section in FIG. 3. As an alternative to electrical resistance wire, a carbon fiber mesh may be used as a type of heater mat.

The fan 30 and the heater mat 32 are both disposed in relation to the lower portion 20 of the seat 12. In this embodiment, the fan 30 is located below the lower portion 20, and the heater mat 32 is located within the lower portion 20 of the seat 12. Hence, both the fan 30 and the heater mat 32 are disposed in relation to the seat 12 such that they are able to carry out their respective functions—i.e., moving and heating the air near the seat surface 24. Both the fan 30 and the heater mat 32 may be positioned in other locations, while still being disposed in relation to the seat 12, provided they are able to perform their intended functions. For example, the fan 30 and the heater mat 32 may be disposed in relation to the back portion 22 of the seat 12. In addition, multiple fans and heater mats may be used in any seat, being disposed in relation to a lower portion and a back portion of a seat, simultaneously.

The heater mat 32 may be used to increase the temperature of the seat 12 when it is determined that the seat is too cool. Specifically, the temperature sensor 14 sends a first signal to the ECU 18, where it is compared with a first predetermined temperature. The first predetermined temperature may be entered into the preprogrammed algorithm, or as explained below, may be manually input by a vehicle occupant. The comparison of the first signal with the first predetermined temperature yields a first temperature differential. When the first temperature differential indicates that the first predetermined temperature exceeds the temperature sensed by the sensor 14, the electronic control unit may increase the heat output of the heater mat 32 to increase the temperature at the surface 24. Of course, increasing the heat output may be accomplished by turning on a heater mat that had previously been turned off.

In addition to serving a general heating function as described above, the heater mat 32 may also be used to help eliminate moisture from the surface 24 of the seat 12. It is well known that increasing the temperature of air increases its ability to hold moisture; thus, the heater mat 32 may be used in conjunction with the fan 30 to transport moisture away from the seat surface 24. Specifically, the moisture sensor 16 sends the second signal to the ECU 18, where it is compared with a predetermined moisture level that has been entered into the preprogrammed algorithm. The comparison of the second signal with the predetermined moisture level yields a first moisture differential. As an alternative to using a predetermined moisture level, the moisture sensor 29 may provide the ECU 18 with a fourth signal related to the ambient moisture in the vehicle. The fourth signal may be compared with the second signal to yield a second moisture differential.

When the first (or second) moisture differential indicates that the moisture sensed by the sensor 16 exceeds the predetermined moisture level (or the ambient moisture level), the ECU 18 may increase the heat output of the heater mat 32 to increase the temperature at the surface 24. This increases the moisture absorbing capability of the air near the surface 24, and causes at least some of the moisture to evaporate. The ECU 18 then activates the fan 30, which draws the moist air through the surface 24, through an air-permeable portion 38 of the seat 12, and out through a duct 40 (see the directional arrows in FIG. 3). The air-permeable portion 38 of the seat 12, may be conveniently made from a relatively stiff, non-woven polyester filler material. Alternatively, other materials that provide a medium through which the air can flow, can also be used. Because the fan 30 moves the air from the surface 24 through other portions of the seat 12, the temperature and moisture sensors 14, 16 may be conveniently located in the air flow path, away from the surface 24.

Although the heater mat 32 may present a convenient mechanism for heating the air near the surface 24 of the seat 12, the use of alternative mechanisms is contemplated. For example, FIG. 4 shows a lower portion 20′ of a seat having a duct 40′ disposed between a fan 30′ and an air-permeable portion 38′. Instead of utilizing a heater mat, such as the heater mat 32 shown in FIG. 3, the heating mechanism in this embodiment comprises electrical resistence wire 42 disposed within the duct 40′. Because the heat generated by the resistance wire 42 may be more localized than the heat produced by a heater mat, use of the resistence wire 42 as a heater mechanism may be especially effective when the fan 30′ moves the air in the opposite direction of the fan 30 shown in FIG. 3 (see the directional arrows in FIG. 4).

The air heated by the resistence wire 42 is blown toward an occupant (not shown), through a porous surface 24′ of the seat. Because the air is heated, it transports moisture away from the occupant and the surface 24′ more efficiently than cool air. In addition, the heated air may be more comfortable to the occupant than cool air. This is because the heated air removes moisture, but does not present to the occupant an uncomfortable draft, which may occur when the air is too cool. Thus, the fan 30′ may be operated at a higher speed than a fan blowing cool air, while still maintaining occupant comfort. This is another advantage of using the heated air, since increasing the volumetric flow rate of the air may increase the speed at which moisture is removed, thereby making the occupant feel comfortable more quickly. After a predetermined period of time, the ECU 18 may reduce the fan speed, the heat output, or both. Of course, one or both devices may be turned off completely.

As an alternative to having the ECU 18 automatically adjust the fan speed or heat output, manual controls 44 (see FIG. 1) may be provided at or near each seat. In addition to allowing a vehicle occupant to adjust the fan speed or air flow direction, the manual controls 44 may also be configured to allow the vehicle occupant to set a desired temperature for the seat (the first predetermined temperature). In addition, as explained below, the manual controls 44 may also be configured to allow the vehicle occupant to set a desired temperature for the ambient air surrounding the seat (a second predetermined temperature.)

In addition to the fan 30 and the heater mat 32, the set of climate control devices in this embodiment includes an ambient air heating and cooling subsystem 46 (see FIG. 1). A heating and cooling subsystem, such as the heating and cooling subsystem 46, will often include the vehicle's central heating and air conditioning system. Alternatively, the heating and cooling subsystem may comprise localized heating, ventilating, and air conditioning (HVAC) systems. These may be conventional systems—e.g., ones that utilize a heat exchanger such as an engine heater core to heat the ambient air, and a vapor-compression system to cool the ambient air—or they may be systems which utilize thermoelectric or other less traditional heating and cooling devices.

The heating and cooling subsystem 46 selectively conditions the ambient air within the passenger compartment of the vehicle to increase or maintain occupant comfort. This may include heating or cooling the ambient air, reducing the moisture in the ambient air, or some combination thereof. The operation of the heating and cooling subsystem 46 is controlled by the ECU 18, which may have the second predetermined temperature previously entered into the preprogrammed algorithm. Alternatively, the ECU 18 may be configured to allow a vehicle occupant to set the second predetermined temperature through use of the manual controls 44. When the ECU 18 processes the inputs from one or more of the sensors 14, 16, 28, 29, and/or the manual controls 44, the heating and cooling subsystem 46 may be operated alone, or in conjunction with, a fan and heating mechanism, such as the fan 30 and the heater mat 32.

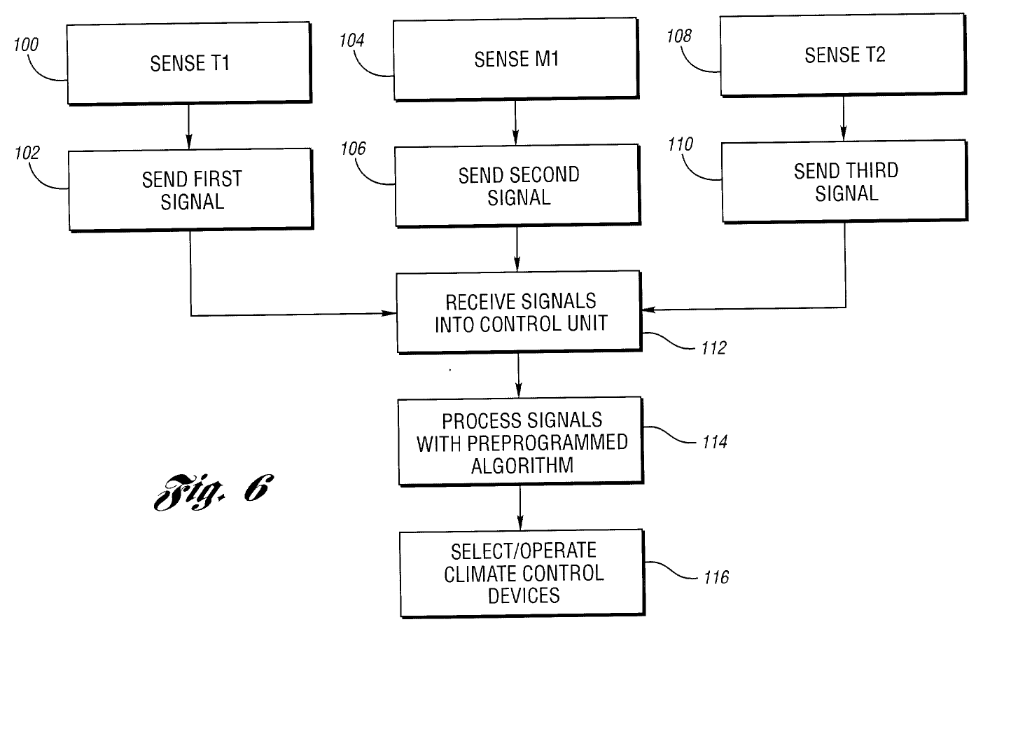

As an alternative to providing a separate heating mechanism for the vehicle seats, such as the heater mat 32 (see FIG. 3), a heating and cooling subsystem, such as the heating and cooling subsystem 46 illustrated in FIG. 1, may be used to heat the air near the surface of a seat. FIG. 5 shows a vehicle seat 48, including a back portion 50 and a lower portion 52. The lower portion 52 comprises a porous surface 54 with an air-permeable portion (not visible) disposed below it. A flexible conduit 56, having an optional diffuser 58, is in fluid communication with the air permeable portion of the seat 48. In this embodiment, the conduit 56 will be attached to a heating and cooling subsystem, such as the heating and cooling subsystem 46 illustrated in FIG. 1. Thus, a heating and cooling subsystem is used in place of a separate heating mechanism to warm the air near the surface 54 of the seat 48. It should be noted that the back portion 50 of the seat 48, may have its own conduit to provide air through an air-permeable portion and a porous surface. Alternatively, an air-permeable portion of the back portion 50 may be in fluid communication with the air-permeable portion of the lower portion 52, such that the conduit 56 provides warm air to both the lower portion 52 and the back portion 50. Since a heating and cooling subsystem, such as the heating and cooling subsystem 46, can provide both warm and cool air, the conduit 56 may transport cool air to the seat 48 when the moisture level is low and the temperature is higher than desired.

As may be readily gleaned from the discussion above, the present invention provides a variety of methods for using the aforementioned climate control system. Referring to FIG. 6 in conjunction with FIG. 1, one such method is herein described. In step 100, the temperature (T1) at or near the surface of a seat is sensed by a first temperature sensor such as the temperature sensor 14. A first signal, related to T1, is sent to an electronic control unit such as the ECU 18 (see block 102). Next, the moisture (M1) at or near the surface of the seat is sensed by a first moisture sensor such as the moisture sensor 16 (see block 104). As represented in block 106, a second signal, related to M1, is then sent to the electronic control unit. The temperature (T2) of ambient air within the vehicle is sensed by a second temperature sensor such as the temperature sensor 28, and a third signal, related to T2, is sent to the control unit (see blocks 108, 110).

Although the sensing of the temperature and moisture is described sequentially, it may occur simultaneously, or in any order. Moreover, more than one temperature and moisture sensor may be used to sense each of the values T1, M1, and T2. In such a case, the first, second, and third signals may represent average conditions sensed at the seat or in the ambient air. As illustrated in block 112, each of the signals is received by the control unit and then processed based on the preprogrammed algorithm (see block 114). Finally, one or more climate control devices, such as a fan, a heating mechanism, and a heating and cooling subsystem, may be operated to increase or maintain the comfort level of the vehicle occupants.

The specific climate control devices selected for operation, and how they are operated, will depend on the results of the processing of the input signals by the control unit. Using FIGS. 1, 2 and 6 for reference, some examples are given. As described above, during the processing by the ECU 18, the first signal may be compared to a first predetermined temperature to determine the first temperature differential. When T1 exceeds the first predetermined temperature, the ECU 18 may respond by: increasing the speed of the fan 30, decreasing the heat output of the heater mat 32, increasing the cooling output of the heating and cooling subsystem 46, or any combination thereof. Conversely, when the first predetermined temperature exceeds T1, the ECU 18 may respond by: decreasing the speed of the fan 30, increasing the heat output of the heater mat 32, increasing the heat output of the heating and cooling subsystem 46, or any combination thereof.

Also during the processing by the ECU 18, the second signal may be compared to a predetermined moisture level to determine the first moisture differential. As previously described, an ambient moisture level measured by a second moisture sensor, such as the sensor 29, may be used in place of a predetermined moisture level, to determine the second moisture differential. When M1 exceeds the predetermined (or ambient) moisture level, the ECU 18 may respond by increasing the heat output of the heater mat 32, and/or increasing the speed of the fan 30. Conversely, when the predetermined (or ambient) moisture level exceeds M1, the ECU 18 may respond by decreasing the heat output of the heater mat 32, and/or decreasing the speed of the fan 30. Similarly, T2 may be compared with the second predetermined temperature to yield a second temperature differential. When the second temperature differential indicates that T2 exceeds the second predetermined temperature, the ECU 18 may respond by: increasing the speed of the fan 30, decreasing the heat output of the heater mat 32, increasing the cooling output of the heating and cooling subsystem 46, or any combination thereof. Conversely, when the second predetermined temperature exceeds T2, the ECU 18 may respond by: decreasing the speed of the fan 30, increasing the heat output of the heater mat 32, increasing the heat output of the heating and cooling subsystem 46, or any combination thereof.

The specific climate control devices chosen for operation from a given set of climate control devices, and how those devices are operated, are part of the climate control strategy developed by the processing of the various input signals by the electronic control unit using the preprogrammed algorithm. Each of these parameters may be changed to modify the climate control system. For example, the input signals sent to the control unit may vary, depending on the type, quantity, and location of each of the sensors. In addition, the set of climate control devices may change, such that the control unit has more (or less) devices to operate. Thus, the climate control system of the present invention is versatile, and allows vehicle designers a number of options when developing a system and method of climate control for the interior of a vehicle.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A climate control system for controlling the climate in a passenger compartment of a vehicle, the vehicle having a seat and at least one ambient air heating and cooling subsystem, the climate control system comprising:
a fan disposed in relation to the seat for selectively moving air through at least one surface of the seat;
a heating mechanism disposed in relation to the seat for selectively heating the air being moved through the at least one surface of the seat;
a first temperature sensor disposed in relation to the seat for sensing the temperature near a surface of the seat, and for sending an electronic signal related to the temperature sensed;
a first moisture sensor disposed in relation to the seat for sensing the presence of moisture near a surface of the seat, and for sending an electronic signal related to the amount of moisture sensed; and
an electronic control unit for receiving signals from at least the first temperature sensor and the first moisture sensor, and for controlling the operation of the fan, the heating mechanism, and the at least one ambient air heating and cooling subsystem, based on the signals received from at least the first temperature sensor and the first moisture sensor.

2. The climate control system of claim 1, wherein the fan is selectively operable to move air to and from the at least one surface of the seat.

3. The climate control system of claim 1, wherein the heating mechanism comprises electrical resistance wire disposed near the at least one surface of the seat.

4. The climate control system of claim 1, further comprising a duct disposed in relation to the fan, for facilitating movement of the air to and from the at least one surface of the seat.

5. The climate control system of claim 4, wherein the heating mechanism comprises electrical resistance wire disposed in the duct.

6. The climate control system of claim 1, wherein the heating mechanism comprises a flexible conduit disposed between the at least one ambient air heating and cooling subsystem and the seat.

7. The climate control system of claim 1, wherein the first moisture sensor comprises a resistive hygrometer.

8. The climate control system of claim 1, wherein the first moisture sensor comprises a capacitive hygrometer.

9. The climate control system of claim 1, further comprising a second temperature sensor disposed in the passenger compartment of the vehicle for sensing the temperature of the ambient air, and for sending an electronic signal related to the temperature sensed to the electronic control unit.

10. The climate control system of claim 1, further comprising a second moisture sensor disposed in the passenger compartment of the vehicle for sensing the moisture in the ambient air, and for sending an electronic signal related to the moisture sensed to the electronic control unit.

11. The climate control system of claim 1, wherein the fan, the heating mechanism, and the at least one heating and cooling subsystem comprise a set of climate control devices.

12. The climate control system of claim 11, further comprising a manual controller, configured for operation by a vehicle occupant, for controlling at least one of the climate control devices in the set of climate control devices.

13. A climate control system for controlling the climate in a passenger compartment of a vehicle having a seat, the climate control system comprising:
a first temperature sensor disposed in relation to the seat for sensing the temperature near a surface of the seat, and for sending an electronic signal related to the temperature sensed;
a first moisture sensor disposed in relation to the seat for sensing the presence of moisture near a surface of the seat, and for sending an electronic signal related to the amount of moisture sensed;
an ambient air heating and cooling subsystem for selectively conditioning ambient air within the passenger compartment of the vehicle; and
an electronic control unit for receiving signals from at least the first temperature sensor and the first moisture sensor and controlling the operation of the ambient air heating and cooling subsystem based on the signals received from at least the first temperature sensor and the first moisture sensor.

14. A method of controlling the climate in a passenger compartment of a vehicle having a seat, the method comprising:
sensing the temperature near the interface of a seated occupant and the seat, and sending a first signal related to the temperature sensed to an electronic control unit;
sensing the moisture near the interface of the seated occupant and the seat, and sending a second signal related to the amount of moisture sensed to the electronic control unit;
processing at least the first and second signals with the electronic control unit based on a preprogrammed algorithm; and
selectively operating at least one climate control device, chosen from a set of climate control devices, based on the processing by the electronic control unit, the set of climate control devices including,
a) a fan disposed in relation to the seat for selectively moving air to and from the interface of the seated occupant and the seat,
b) a heating mechanism disposed in relation to the seat for selectively heating the air being selectively moved to and from the interface of the seated occupant and the seat, and
c) an ambient air heating and cooling subsystem.

15. The method of claim 14, wherein selectively operating at least one climate control device, chosen from the set of climate control devices, comprises:
heating the air near the interface of the seated occupant and the seat with the heating mechanism, thereby evaporating at least some of the moisture near the interface;
moving the heated air away from the interface of the seated occupant and the seat with the fan; and
discontinuing use of the heating mechanism after a predetermined period of time.

16. The method of claim 14, wherein sensing the temperature near the interface of the seated occupant and the seat, comprises sensing the temperature with a plurality of temperature sensing devices disposed below a surface of the seat.

17. The method of claim 14, wherein the preprogrammed algorithm includes comparing the first signal with a first predetermined temperature to determine a first temperature differential.

18. The method of claim 17, further comprising at least one of the following when the first temperature differential indicates that the temperature near the interface of the seated occupant and the seat exceeds the first predetermined temperature,
a) increasing the speed of the fan,
b) decreasing the heat output of the heating mechanism,
c) increasing the cooling output of the ambient air heating and cooling subsystem.

19. The method of claim 17, further comprising at least one of the following when the first temperature differential indicates that the first predetermined temperature exceeds the temperature near the interface of the seated occupant and the seat,
a) decreasing the speed of the fan,
b) increasing the heat output of the heating mechanism,
c) increasing the heat output of the ambient air heating and cooling subsystem.

20. The method of claim 14, wherein the preprogrammed algorithm includes comparing the second signal with a predetermined moisture level to determine a first moisture differential.

21. The method of claim 20, further comprising at least one of the following when the first moisture differential indicates that the moisture near the interface of the seated occupant and the seat exceeds the predetermined moisture level,
a) increasing the heat output of the heating mechanism,
b) increasing the speed of the fan.

22. The method of claim 20, further comprising at least one of the following when the first moisture differential indicates that the predetermined moisture level exceeds the moisture near the interface of the seated occupant and the seat,
a) decreasing the heat output of the heating mechanism,
b) decreasing the speed of the fan.

23. The method of claim 14, further comprising sensing the temperature of ambient air in the passenger compartment of the vehicle, sending a third signal to the electronic control unit, and processing the third signal with the electronic control unit based on the preprogrammed algorithm.

24. The method of claim 23, wherein the preprogrammed algorithm includes comparing the third signal with a second predetermined temperature to determine a second temperature differential.

25. The method of claim 24, further comprising at least one of the following when the second temperature differential indicates that the ambient air temperature exceeds the second predetermined temperature,
a) increasing the speed of the fan,
b) decreasing the heat output of the heating mechanism,
c) increasing the cooling output of the ambient air heating and cooling subsystem.

26. The method of claim 24, further comprising at least one of the following when the second temperature differential indicates that the first predetermined temperature exceeds the ambient air temperature,
a) decreasing the speed of the fan,
b) increasing the heat output of the heating mechanism,
c) increasing the heat output of the ambient air heating and cooling subsystem.

27. The method of claim 14, further comprising sensing the moisture of ambient air in the passenger compartment of the vehicle, sending a fourth signal to the electronic control unit, and processing the fourth signal with the electronic control unit based on the preprogrammed algorithm.

28. The method of claim 27, wherein the preprogrammed algorithm includes comparing the second signal with the fourth signal to determine a second moisture differential.

29. The method of claim 14, further comprising providing a flexible conduit between the ambient air heating and cooling subsystem and the seat, thereby providing heated or cooled air to the seat when the ambient air heating and cooling subsystem is chosen for selective operation from the set of climate control devices.

30. A method of controlling the climate in a passenger compartment of a vehicle having a seat, the method comprising:
sensing the temperature near the interface of a seated occupant and the seat, and sending a first signal related to the temperature sensed to an electronic control unit;
sensing the moisture near the interface of the seated occupant and the seat, and sending a second signal related to the amount of moisture sensed to the electronic control unit;
processing at least the first and second signals with the electronic control unit based on a preprogrammed algorithm; and
selectively operating an ambient air heating and cooling subsystem based on the processing by the electronic control unit.

31. A method of controlling the climate in a passenger compartment of a vehicle having a seat, the method comprising:
using a preprogrammed algorithm in an electronic control unit to process input signals from at least a temperature sensor and a moisture sensor disposed in the seat; and
selectively operating at least one climate control device, chosen from a set of climate control devices, using the preprogrammed algorithm.

32. The method of claim 31, wherein the set of climate control devices comprises:
a fan, disposed in relation to the seat for selectively moving air to and from a surface of the seat;
a heating mechanism, disposed in relation to the seat for selectively heating the air being selectively moved to and from the surface of the seat; and
an ambient air heating and cooling subsystem.

33. The method of claim 31, further comprising:
sensing the temperature of ambient air in the passenger compartment of the vehicle;
sending a supplemental input signal to the electronic control unit based on the ambient air temperature sensed; and
processing the supplemental input signal with the electronic control unit using the preprogrammed algorithm.
